(19) United States
(12) Patent Application Publication
(10) Pub. No.: US 2024/0353552 A1
(43) Pub. Date: Oct. 24, 2024

(54) RADAR SIGNAL MATCHING FOR SELF-POSITIONING

(71) Applicant: Telefonaktiebolaget LM Ericsson (publ), Stockholm (SE)

(72) Inventors: Henrik Sjöland, Lund (SE); Ashkan Kalantari, MALMÖ (SE); Fredrik Dahlgren, Lund (SE); Magnus Sandgren, STAFFANSTORP (SE); Gang Zou, Lund (SE); Andres Reial, HÖLLVIKEN (SE); Magnus Olsson, KLAGSHAMN (SE)

(21) Appl. No.: 18/713,897

(22) PCT Filed: Nov. 30, 2021
(86) PCT No.: PCT/EP2021/083580

§ 371 Date: May 28, 2024

(51) Int. Cl. G01S 13/42; G01S 13/86; G01S 13/87; G01S 13/89

(52) U.S. Cl. CPC G01S 13/426; G01S 13/86; G01S 13/876; G01S 13/89

(57) ABSTRACT

A position of a mobile communication device is determined by obtaining a first set of candidate signal templates, wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy. A first radar echo signal is obtained, and a first test signal is produced by encoding magnitude values of the first radar echo signal in accordance with the first magnitude encoding strategy. The first test signal is correlated with each candidate signal template in the first set of candidate signal templates to obtain a first set of respective correlation results. A second set of candidate positions is produced by using the first correlation results as a basis for selecting fewer than all of the candidate positions from the first set of candidate positions. A second set of candidate signal templates is obtained, wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy.

### BACKGROUND

The present invention relates to technology that enables a mobile communication device to obtain information indicative of its location and more particularly to technology that utilizes radar information to assist with determining the information indicative of a mobile communication device's location.

There is a growing need for applications in modem-equipped devices to be aware of their own geographic positions (“self-position”) with high accuracy. There are several radio-based positioning technologies related to cellular communication as well as Bluetooth-compliant technology providing the positioning accuracy of a few meters (better under certain conditions). In US Patent Publication No. US20170307746A1 (published in 2017), a vehicle compares a radar map with a reference data map to localize itself. In US Patent Publication No. US20190171224A1 (published 2019) a vehicle creates a map of its environment in a first step and then uses the environment features and stationary reflections to localize itself; non-stationary objects are identified to not cause location errors. The referenced patent mentions relative velocity (self-movement) can be derived based on the stationary objects and relative changes from radar images (relative change of radial speed of the reflection points) this also allows determination of rotation when using multiple spatial distributed radar sensors. Deterministic and stochastic radar responses are used in Liu et al., A Radar-Based Simultaneous Localization and Mapping Paradigm for Scattering Map Modeling, IEEE Asia-Pacific Conference on Antennas and Propagation (APCAP), Auckland, New Zealand (2018), to build a map of the environment and localize the radar. US Patent Publication No. US20200233280A1 discloses a method for determining the position of a vehicle by matching radar detection points with a predefined navigation map which comprising elements representing static landmarks around the vehicle. The publication also mentions that the navigation map can be derived from a global database on the basis of a given position of the vehicle, e.g. from a global position system of the vehicle. The approach described in Marck et al., “Indoor Radar SLAM A Radar Application For Vision And GPS Denied Environments”, European Microwave Conference, Nuremberg, Germany (2013) involves feeding the radar image into a mapping and localization algorithm and using an iterative closest point algorithm to determine the radar location and movement, whereas a particle filter optimizes measurement performance. As shown in Marck et al., radar-based Simultaneous Localization and Mapping (SLAM) generally requires 360 degrees panoramic high-resolution range information which can be achieved by either a radar apparatus with rotating antenna or an electronically scanned phased array radar.

In another disclosure, US Patent Publication No. US20200256977A1 (published 2020) describes a vehicle using at least one radar sensor to generate a map of the environment and then comparing its current measurement with the generated map to localize itself. As similarly disclosed in US Patent Publication No. US20200232801A1, a vehicle uses radar to create a local map and then retrieves a map of the environment and correlates the two to localize itself. And as described in US Patent Publication No. US20190384318A1, a device uses a radar signal to create a local grid map and compares this with a map stored in the device's memory to localize itself.

Other sensor options for localization include the use of cameras where techniques such as SLAM can support a more accurate relative position. Information from different sensors may be combined in so-called sensor fusion. Using radar-based SLAM, a device can map an unknown environment and localize itself in the environment.

There are a number of problems associated with conventional positioning technology. For example, radio-based positioning that relies exclusively on the communication between one or a few base stations or anchor points and a device produces results that are accurate only down to within a few meters unless a large number of anchor transmitters are provided, the clock synchronization among them is extremely accurate, or certain assumptions can be made on the environment or relative position. Such systems scale poorly with respect to accuracy and cost. Furthermore, the positions of the base stations or access points also need to be very accurately known, which adds to installation cost and can cause problems if these are moved later on.

As the deployment of indoor base stations foremostly aims to cater to coverage of communication services, it is very likely that there could be significant gaps in coverage of the areas that can obtain an accurate enough position. In some cases it might even lead to zones and spots where conventional positioning technology works poorly (even though, in some cases, communication may still be possible).

An alternative approach, sensor fusion, which combines sensor data from SLAM with, for example, data derived from radio-based positioning, GPS, and/or cameras, and inertial measurement units (IMUs) for movement changes, can lead to high accuracy, but demands multiple sensors which adds significant complexity, cost, and device size.

PCT Publication No. WO2017139432 (published 9 Feb. 2017) presents a solution for fingerprinting local depth-based sensor data with map-data of geometric structures. The fingerprinting is based on geometric analysis. Radar is mentioned as one many different types of potential sensors that may be used to generate depth-wise information. However, the fingerprinting is not based on radar-signals.

Patent Publication No. US20190171224A1 (published 6 Jun. 2019) presents a radar-based technique for fine-tuning self-position based on first creating a map of the environment and thereafter fine-tuning self-position by correlating to that map. Both the map and the fine-tuning are performed by the device. The target area is vehicles with an aim to, for example, enable autonomous parking.

There is therefore a need for self-positioning technology that addresses the above and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) for determining a position of a mobile communication device. Position determination comprises obtaining a first set of candidate signal templates, wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy; and obtaining a first radar echo signal. A first test signal is produced by encoding magnitude values of the first radar echo signal in accordance with the first magnitude encoding strategy. The first test signal is correlated with each candidate signal template in the first set of candidate signal templates to obtain a first set of respective correlation results. A second set of candidate positions is produced by using the first correlation results as a basis for selecting fewer than all of the candidate positions from the first set of candidate positions. A second set of candidate signal templates is obtained, wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy. In another aspect of some but not necessarily all embodiments consistent with the invention, the first magnitude encoding strategy comprises representing each signal magnitude by a magnitude value selected from only two possible values; and the second magnitude encoding strategy comprises representing each signal magnitude by a magnitude value selected from more than two possible values.

In yet another aspect of some but not necessarily all embodiments consistent with the invention, a second test signal is obtained by encoding magnitude values of the first radar echo signal in accordance with the second magnitude encoding strategy; and the position of the mobile communication device is determined by correlating the second test signal with each candidate signal template in the second set of candidate signal templates.

In still another aspect of some but not necessarily all embodiments consistent with the invention, a second test signal is obtained by obtaining a second radar echo signal and encoding magnitude values of the second radar echo signal in accordance with the second magnitude encoding strategy; and the position of the mobile communication device is determined by correlating the second test signal with each candidate signal template in the second set of candidate signal templates.

In another aspect of some but not necessarily all embodiments consistent with the invention, each of the candidate position templates in the first set of candidate signal templates and each of the candidate position templates in the second set of candidate signal templates is further associated with a direction of radar signal transmission.

In yet another aspect of some but not necessarily all embodiments consistent with the invention, each of the candidate position templates in the first set of candidate signal templates and each of the candidate position templates in the second set of candidate signal templates comprises information indicating a measure of radar echo signal energy and a time delay corresponding to the radar echo signal energy.

In still another aspect of some but not necessarily all embodiments consistent with the invention, correlating the first test signal with each candidate signal template in the first set of candidate signal templates to obtain a first set of respective correlation results comprises using the information indicating the time delay corresponding to the radar echo signal energy as a basis for applying different weights to different correlation results of the first set of correlation results.

In another aspect of some but not necessarily all embodiments consistent with the invention, determining the position of the mobile communication device comprises selecting, as the position of the mobile communication device, one of the candidate positions that correspond to the candidate signal templates of the second set of candidate signal templates, wherein the selecting is based on correlation results obtained by correlating the second test signal with each candidate signal template in the second set of candidate signal templates.

In yet another aspect of some but not necessarily all embodiments consistent with the invention, determining the position of the mobile communication device comprises obtaining an initial estimate of the position of the mobile communication device, wherein the initial estimate of the position of the mobile communication device is derived from one or more of:
signaling from a global satellite positioning system; and
Observed Time Difference Of Arrival, OTDOA, technology;
Round Trip Time, RTT, technology;
Angle of Arrival, AoA, technology;
Angle of Departure, AoD, technology; and
UpLink Time of Arrival, UL ToA, technology; and

selecting the first set of candidate signal templates from a plurality of different sets of candidate position templates, wherein the selecting is based on the initial estimate of the position of the mobile communication device.

In still another aspect of some but not necessarily all embodiments consistent with the invention, obtaining the first radar echo signal comprises the mobile communication device transmitting a radar signal and receiving the first radar echo signal; and correlating the first test signal with each candidate signal template in the first set of candidate signal templates to obtain the first set of respective correlation results is performed by the mobile communication system node that serves the mobile communication device.

In another aspect of some but not necessarily all embodiments consistent with the invention, correlating the first test signal with each candidate signal template in the first set of candidate signal templates to obtain the first set of respective correlation results is performed by the mobile communication device.

### BRIEF DESCRIPTION OF THE DRAWINGS

The objects and advantages of the invention will be understood by reading the following detailed description in conjunction with the drawings in which:

FIG. 1A is, in one respect, a flowchart of actions performed in accordance with a number of embodiments consistent with the invention.

FIG. 1B is, in one respect, a flowchart of actions performed in accordance with a number of embodiments consistent with the invention.

FIG. 2 illustrates an exemplary scenario in which aspects of inventive embodiments are practiced.

FIG. 3A illustrates exemplary radar signal echoes, along with a threshold for deriving single bit representations of the magnitudes of the echoes.

FIG. 3B illustrates an exemplary resultant quantization of radar signal echoes, one for each of three exemplary beams.

FIGS. 3C and 3D illustrate exemplary 2-dimensional polar coordinate representations of quantized radar reflection information collected from 36 beam directions, one with multi-bit representations of radar reflection magnitudes and the other with 1-bit quantized representations of radar reflection magnitudes.

FIG. 4 shows details of a network node according to one or more embodiments.

FIG. 5 shows details of a wireless device according to one or more embodiments.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

The herein-described technology addresses the need for a device to be able to obtain an accurate positioning of itself (so called “ego-position” or self-position) in a processing-efficient way. Conventional radio-based position solutions can achieve an accuracy of about +5-10 meters, which can be potentially better in favorable conditions, but also potentially worse in unfavorable radio wave propagation environments. This is insufficient for many applications, and a self-position with refined accuracy is therefore estimated by capturing radar signals at multiple frequencies (e.g., because different frequencies have different reflection properties, and this in turn produces more information about objects and features in an environment) and directions (depending on beamforming capabilities of the radar device directions) and then applying signal matching techniques in which the provided radar signal reflections (also referred to herein as radar echo signals) are correlated with previously captured radar signal reflections from the environment around the coarse (i.e., less reliably accurate) position. The signal matching can be achieved by, in some embodiments, uploading the captured radar reflections to a server (which can be located at a mobile edge node) and having the server handle the processing. In alternative embodiments, the device itself performs the processing, but with the penalty of higher power draw.

The correlation process starts by identifying the parts of the radar signal that contain echoes (i.e., parts that are distinctly above a noise floor). The result is a bit-mask in which each time delay position represents one of two possible values: echo or no echo. This bit-mask is then correlated with previously obtained reference representations (e.g., stored in a database). Formatting the information in this way makes it suitable for correlation with a large number of signals, since the size of the signals is small with just one-bit data, and the required correlators also consume less energy and work fast. After correlating signals in several directions, fewer potential positions remain as possible candidates. Additionally, or alternatively, the echoes may further be filtered based on delay (i.e., only echoes in certain delay ranges, below or above distance thresholds may be considered).

In a next action, the correlation takes into account the shape of the echoes that are distinctly above the noise floor, and the relative strength between the echoes. To enable this processing, an echo signal is interpolated and oversampled. The two signals to be compared (i.e., the echo signal and one of a number of candidate reference signals, which in some embodiments are also interpolated and oversampled) can then be better time aligned, and then scaled so that their average magnitudes are equal. The time alignment giving the minimum averaged squared error (difference) is found, and the minimum squared average error is then related to the squared peak magnitude, giving a measure of the shape difference of the echo. This is then repeated for all echoes. The scaling factors used for the fitting of the different echoes can be used to measure how well the relative strength of the echoes fit the radar signal of the database. For a perfect fit, all scaling factors should be equal (i.e., because there would be no variation). Accordingly, to obtain a quality measure of the fit, the mean value and standard deviation of the scaling factor are calculated, and the ratio of the two is determined.

In some embodiments, thresholds can be defined for the matching level of the echo shapes and relative strengths, and if a position in the database has radar signals that match the observed radar signal with better fit than the threshold, it is identified as a potential position of the device.

In further alternatives, the range of round-trip times that are included in the comparison can also be variable, or the accuracy threshold can be distance dependent, as there may be a higher risk that far away objects are obscured. Another possibility is to, in the comparison, exclude a few echoes in the database signal or the observed radar signal that do not have correspondence, since objects may have moved, appeared or disappeared.

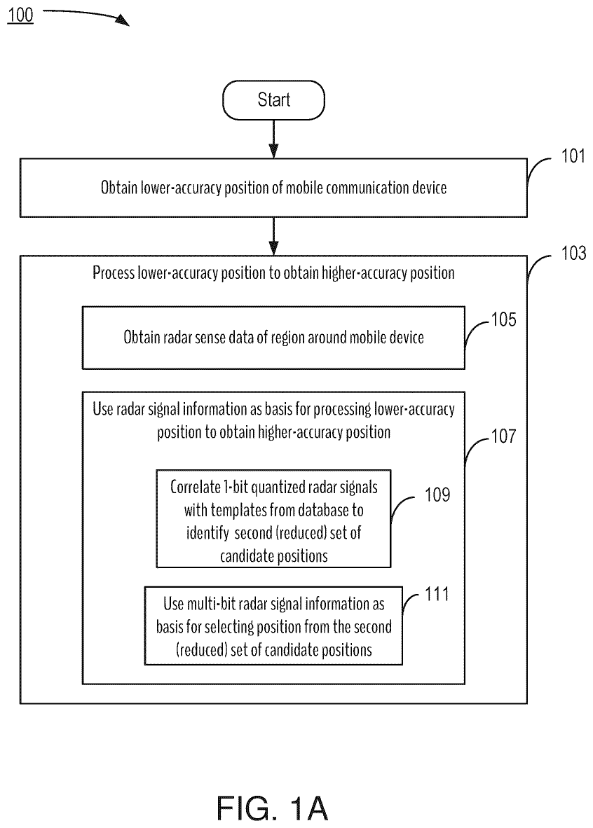

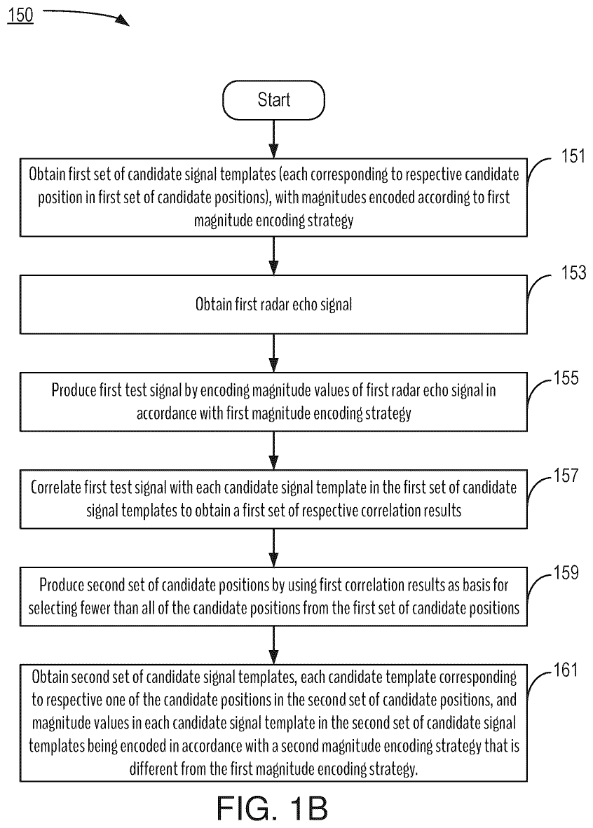

Further aspects of inventive embodiments are now described with reference to FIG. 1A, which is, in one respect, a flowchart of actions performed by, in some embodiments, an exemplary mobile communication device; in some other embodiments an exemplary server (e.g., a network component configured to have edge mobility functionality) configured to determine a location of a mobile communication device; and in still other embodiments a combination of the two. In other respects, the blocks depicted in FIG. 1A can also be considered to represent means 100 (e.g., hardwired or programmable circuitry or other processing means) for carrying out the described actions.

As shown in FIG. 1A, the process includes obtaining a lower-accuracy position of the mobile communication device, wherein the lower-accuracy position indicates the location of the mobile communication device with a first degree of accuracy (step 101). The lower-accuracy position can be obtained by conventional means. As mentioned earlier, conventional radio-based position solutions can achieve an accuracy of about +5-10 meter (potentially better under favorable conditions and/or in higher bands, but potentially worse in unfavorable radio wave propagation environments).

The acting entity (i.e., mobile communication device, server, or combination of the two) then processes the lower-accuracy position to obtain a higher-accuracy position (step 103).

The processing of step 103 comprises obtaining radar sense data of the region around the mobile communication device (step 105) and then using the radar signal information as a basis for processing the lower-accuracy position to obtain the higher-accuracy position (step 107). In some embodiments, the lower-accuracy position is used as a world reference position (WRP), and then radar sensing is used to finetune the position within the WR frame. In the following, the term “WRP” is used to refer to the estimated world reference position according to a standardized radio-based method such as Observed Time Difference Of Arrival (OTDOA). Other approaches can be used as alternatives to determine the WRP. The term “WR-Frame” is used herein to refer to the local area around the WRP as defined by the estimated accuracy of WRP. For example, if the accuracy of WRP is estimated to be #5 meters, then the WR-Frame is the area defined by WRP +5 meters in each direction. More generally, the WR-Frame is an exemplary embodiment of a local area portion of a reference coordinate system (which, in this embodiment, is the world reference map). The estimate of accuracy can be based on the particular method used, deployment characteristics and estimates of key components building up the uncertainty such as e.g., synchronization errors. In some embodiments, a database of historical information relating to “fine tuning” of initial position estimates within specific areas and, in some cases related to specific device capabilities, can also be used to assist with estimating WRP accuracy.

The processing of step 107 comprises correlating (e.g., signal matching) 1-bit quantized representations of the magnitudes of radar signal reflections with a full set of relevant templates (e.g., previously captured radar reflections from the environment of the WR-Frame) that correspond to respective members of a first set of candidate positions. The full set of relevant templates are obtained from a database. Correlation results are used to identify the most likely candidate positions (step 109). In this correlation, each template in the full set of relevant templates is formed in accordance with the same magnitude encoding strategy as is used for the radar signal reflections; that is, in each template, each signal magnitude is represented by a magnitude value selected from only two possible values. Identifying the most likely candidate positions (step 109) involves producing a second set of candidate positions by using the first correlation results as a basis for selecting fewer than all of the candidate positions from the first set of candidate positions. As a result, the identified most likely candidate positions constitute a reduced set of candidate positions compared to the full set of relevant templates. Multi-bit radar signal information (e.g., derived from the same collected radar signals) is then used as a basis for selecting the position of the mobile communication device from the second (reduced) set of candidate positions (step 111). This involves, for example, obtaining a second set of candidate signal templates, wherein each candidate signal template in the second set of candidate signal templates corresponds to a respective one of the candidate positions in the second set of candidate positions. The templates in the second set of candidate signal templates use multi-bit representations of radar signals so that more detailed information can be obtained when they are compared/correlated with the multi-bit radar signal information. Although more processing resources are required to make a multi-bit comparison than a 1-bit comparison, there are fewer comparisons to be performed with respect to the second set of candidate signal templates than for the first set. As a result, net resource savings are achieved.

Using the multi-bit radar signal information as a basis for selecting the position of the mobile communication device from the second set of candidate positions results in a more accurate position that indicates, with a second degree of accuracy, the position of the mobile communication device, wherein the second degree of accuracy is more accurate than the first degree of accuracy. The multi-bit radar signal information can be derived from the same radar reflections that served as the basis for producing the 1-bit quantized representations. Alternatively, another radar transmission can be performed and its reflections captured for use as the multi-bit radar signal information. In some versions of this alternative, the radar transmission can be adapted in some way (e.g., with respect to one or more of power, direction, polarization, frequency band, and the like) based on the results of the initial correlation step 107. But regardless of whether the same radar reflections as were used in the earlier steps or newly acquired radar echo signals are obtained, step 111 involves encoding magnitude values of the radar echo signal in accordance with a second magnitude encoding strategy in which each signal magnitude is represented by a magnitude value selected from more than two possible values (and hence requiring a multi-bit representation). A second set of candidate signal templates is obtained, wherein each candidate signal template in the second set of candidate signal templates corresponds to a respective one of the candidate positions in the reduced set of candidate positions, and with magnitude values in each candidate signal template in the second set of candidate signal templates also being encoded in accordance with the second magnitude encoding strategy.

Further aspects of inventive embodiments are now described with reference to FIG. 1B, which is, in one respect, a flowchart of actions performed by, in some embodiments, an exemplary mobile communication device; in some other embodiments an exemplary server (e.g., a network component configured to have edge mobility functionality) configured to determine a location of a mobile communication device; and in still other embodiments a combination of the two. In other respects, the blocks depicted in FIG. 1B can also be considered to represent means 150 (e.g., hardwired or programmable circuitry or other processing means) for carrying out the described actions.

As shown in FIG. 1B, the process includes obtaining a first set of candidate signal templates (step 151), wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy. A first radar echo signal is obtained (step 153), and a first test signal is produced by encoding magnitude values of the first radar echo signal in accordance with the first magnitude encoding strategy (step 155).

The first test signal is correlated with each candidate signal template in the first set of candidate signal templates to obtain a first set of respective correlation results (step 157). A second set of candidate positions is produced by using the first correlation results as a basis for selecting fewer than all of the candidate positions from the first set of candidate positions (step 159). A second set of candidate signal templates is obtained (step 161), wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy.

As mentioned above with respect to the embodiments illustrated by FIG. 1A, in embodiments illustrated by FIG. 1B the first magnitude encoding strategy advantageously comprises representing each signal magnitude by a magnitude value selected from only two possible values, and the second magnitude encoding strategy comprises representing each signal magnitude by a magnitude value selected from more than two possible values.

Embodiments consistent with the invention involve the use of efficient signal matching techniques, to reduce the number of computations needed to obtain an accurate position with high confidence. As shown in FIGS. 1A and 1B and described above, this involves a two-step approach, starting with a correlation of 1-bit quantized signals to identify a reduced number of candidate positions from a larger number of candidate positions. Then for these identified candidate positions, a more detailed analysis follows, based on comparison with multi-bit data templates to provide high confidence and accuracy. This two-step approach is described further in the following.

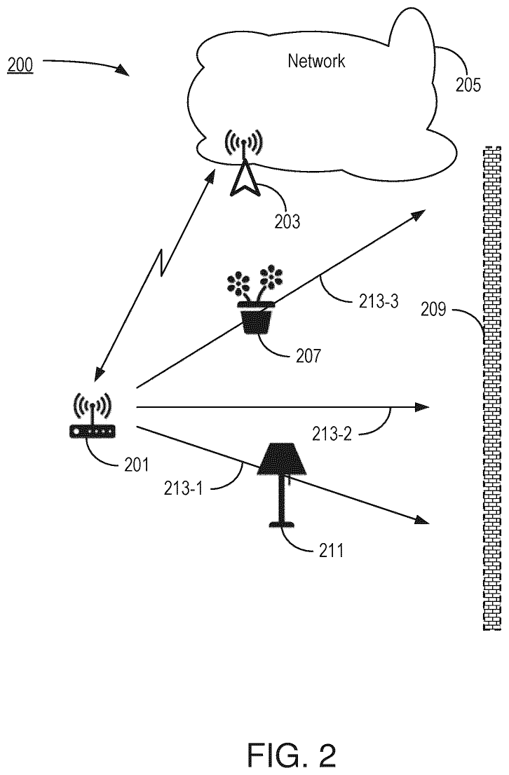

Consider an exemplary scenario as shown in FIG. 2. A mobile device 201 communicates with a node 203 that is part of a network 205 of various kinds of nodes. The mobile device 201 is in an environment 200 that includes a plant 207, a wall 209, and a lamp 211. The mobile device's radar sensing includes sensing in each of three directions: 213-1, 213-2, and 213-3. The three sensing directions 213-1, 213-2, and 213-3 will provide different radar echoes. Direction 213-1 will provide an echo from the lamp 211, and a later echo from the wall 209. Direction 213-2 will just have the echo from the wall 209, which is strong in this case as the surface of the wall 209 is perpendicular to the wave-front. Finally, direction 213-3 will provide an echo from the plant 207 and also from the wall 209.

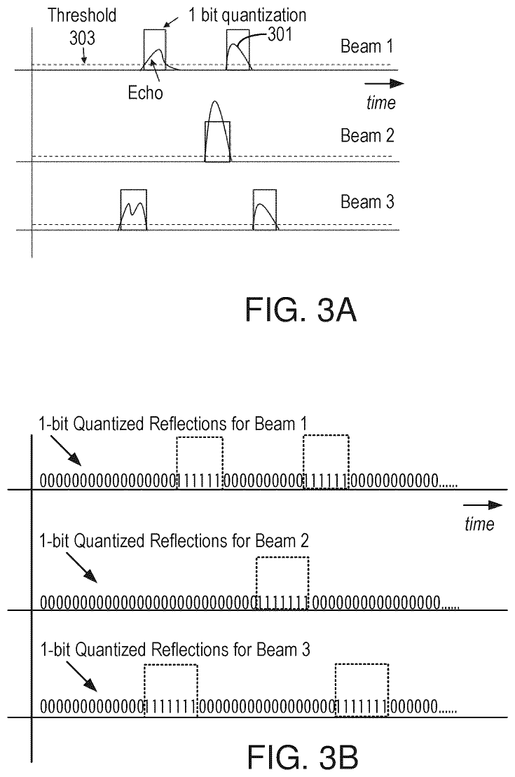

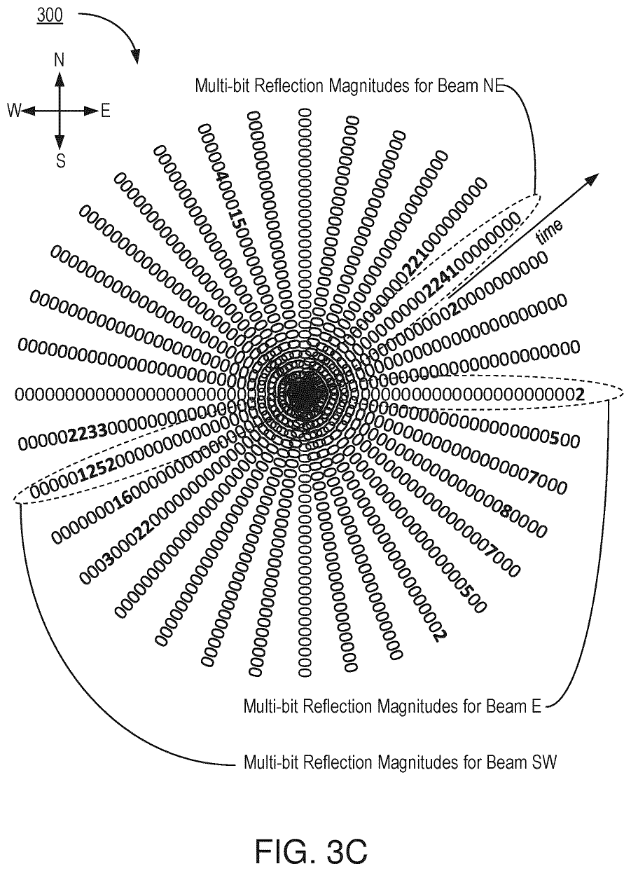

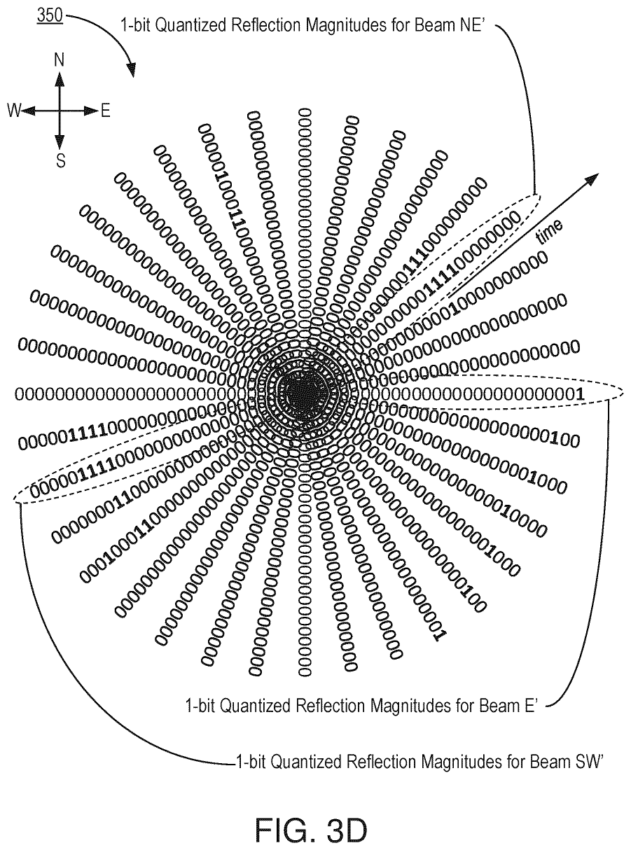

The above-described echoes, along with the single bit representation of the echoes, with quantization being based on an indicated threshold level are illustrated in FIGS. 3A, 3B and 3D. In particular, as shown in FIG. 3A, the magnitude of a radar signal reflection (e.g., the radar signal reflection 301) is quantized to have a value of ‘1’ if it exceeds the indicated threshold 303; otherwise it is assigned a value of ‘0’. FIG. 3B illustrates the quantized magnitude values for the radar reflections shown in FIG. 3A. (Note: Due to different scaling of font size, in order to make the text easier to read, the quantized signal values shown in FIG. 3B do not line up with their counterpart analog representations shown in FIG. 3A. But relative signal placements and widths are intended to be the same.) It is advantageous when quantizing the reflections to set the threshold 303 to a value above a given noise and/or interference floor for the environment 200 and the radar receiver of the device 201. The threshold level should also be set to achieve a desired detection sensitivity (e.g., minimum object size, radar cross-section). The noise and/or interference floors can be estimated from previously acquired sense data of the environment 200 and/or information about the particular receiver being used. To improve performance in some embodiments, before quantization, the received signal is low-pass filtered to suppress receiver noise and interference. The threshold in these embodiments should be set accordingly.

As can be seen in FIG. 3B, the 1-bit values contain a lot of information, such as the time delay (relative to the time of radar signal transmission) and duration of echoes in different directions. In most situations, it is possible to use this information to narrow down the search to a few positions of close match. The fewer the number positions that need to be checked, the more efficient the positioning process is.

The quantized reflection patterns (both actually received as well as templates associated with candidate positions of the device) can be expressed as a set of tables, one for each beam at a given position (e.g., as illustrated in FIG. 3B). In some but not necessarily all alternative embodiments, the resulting 1-bit representation is expressed as a 2-D (or in some embodiments (not shown) 3-D) grid in polar coordinates (with the angle coordinate being based on beam direction, and the magnitude coordinate being based on the detected reflection distances, which corresponds to time delay between radar signal transmission and echo reception). Exemplary grids 300 and 350 are illustrated in respective FIGS. 3C and 3D, again with the understanding that the grids 300 and 350 serve as illustrations both of quantized radar reflections actually received by a device desiring to determine its position as well as templates associated with a candidate position, against which a device's collected radar reflections are compared. The center of each grid 300, 350 represents a position from which the radar beams either were transmitted (when the grids 300, 350 are interpreted to represent radar echoes received by a device) or alternatively a candidate position in a template 300, 350 associated with that position. Each exemplary grid is oriented with North at the top of the grid and South at the bottom, East to the right and West to the left. In FIG. 3C, three exemplary echoes are identified: a multi-bit reflection for a beam NE transmitted in an approximately northeast direction, a multi-bit reflection for a beam E transmitted towards the east, and a multi-bit reflection for a beam SW transmitted in an approximately southwest direction. FIG. 3D shows the corresponding 1-bit quantized reflections NE′, E′, and SW′. The size of the grid is determined by the number of beam directions sounded and the possible/desired distance resolution of radar echoes (including impact of low-pass filtering). Given, for example, a cartesian world referenced (WR) map, polar reference representations for a number of candidate device positions and orientations may be created and the observed polar representations may be correlated against such candidate hypotheses. The hypotheses indicating largest correlations may be selected as candidates for estimated position and orientation.

In another class of embodiments, the resulting 1-bit representation is separated into multiple range regions (i.e., annulus (-li), disk(s) or area(s) outside a disk). For each range region, a simplified 1-D representation may be used, indicating presence or absence of reflections in that range region in a list of angular directions. Initial detection for each candidate position of the mobile device (e.g., User Equipment-UE) compares the closest range(s) where reflections are present, or range regions associated with reflections from most directions, based on the reference representations available in the database or map.

After this step based on 1-bit data, regardless of how the 1-bit data is represented, a reduced number of candidate positions have been identified. The next step is to investigate these identified positions with multi-bit data to identify, with a high degree of confidence, which is the correct candidate, and to potentially further increase the accuracy using the increased amount of information available in multi-bit data representations of the received radar reflections. Accordingly, the received radar signals for different beam directions are re-processed, this time with multi-bit representations. In some but not necessarily all embodiments, the shapes of the echoes are also compared. To do this, oversampling and interpolating may be used to increase time resolution. Time and magnitude of each echo to be investigated are then adjusted so that they will provide the best least-squares fit to the database image of the hypothesized echo. The sum of squared misalignment after fitting, the amount of magnitude adjustment to achieve this fit, the corresponding amount of time adjustment, and the total sum of the squared echo signal are then saved. In some embodiments, this is repeated for all echoes. In alternative embodiments, power and/or processing resources can be saved by performing this only for those radar echoes associated with the candidate positions that are identified as being needed to resolve potential positioning ambiguity or needed to reach a certain (predefined) accuracy level. If an echo in the database or radar measurement lacks correspondence, that may be indicated as an echo with complete mismatch (a larger significance should then be given to mismatched echoes with large energy compared to small, as small objects are in general more likely to change position).

The likelihood of a hypothesized position being correct is then based primarily on matching shape of fitted echoes, that is low relative squared errors for strong echoes and low absolute squared errors of weak echoes. The difference in magnitude adjustments should also be low. If there is an unmatched echo, echoes before that should be the focus and thus be given larger weight, as later echoes may be affected both in shape and magnitude by the unmatched object.

In some but not necessarily all embodiments consistent with the invention, high-resolution correlation scores for individually adjusted and matched echoes in the observed direction or area for a candidate position are accumulated, and the position with the largest accumulated score is determined as the estimated position. In another (alternative) embodiment, high-resolution correlation scores for groups of echoes in one or several directions are evaluated, and the candidate position with the largest score (or sum of scores) is determined as the estimated position.

If needed, position finetuning can be performed using the time adjustments, and these may then be weighted together for all echoes, with more priority given to strong echoes (large and/or nearby objects) since they are affected less by noise. Close echoes may also be given higher weight since the path to these is less likely to be affected by disturbances in the environment.

Position finetuning can also be improved for a device by increasing the number of beam directions during its radar sensing, and by increasing signal bandwidth, output power, performing measurements in more frequency bands, polarizations, and the like, where decisions about suitable radar parameters for these finetuning measurements can be based on the initial correlation and its candidate positions together with historical recorded radar data. All of this will result in increased energy consumption and spectrum usage, however, so such additional resources should only be used if required by the application.

The above-described embodiments rely on access to reference information that is used for testing hypothesized device positions. The databases may contain environment descriptions at required resolutions (e.g., coarse and higher). Alternative types of descriptions may instead be used from which required representations may be derived.

The database with saved radar signals for correlation analysis can be created in different ways. One approach is to start with an enhanced device (ED) containing a radar capability as well as other sensors to determine position with high accuracy. Those other sensors can be, for example, exact distance measuring sensors. The ED is then moved around in the environment while recording radar signal data jointly with the position of ED at each measurement.

Radar signal data can be recorded with different parameter settings: polarization, frequency, bandwidth, beam width, beam directions, and the like. The recorded radar signals are used as a basis for creating the 1-bit representative data that is used for fast and energy-efficient initial correlation as described above. In some but not necessarily all embodiments consistent with the invention, high-fidelity measurements may be performed and 1-bit versions created based on the high-resolution data.

After the initial database has been created based on data from an enhanced device, this data can be iteratively improved and/or updated. For example in some embodiments, when new radar signals are received and the corresponding position is determined, the radar data and position are stored in the database. Deviations from the original database data might appear due to objects being moved. When multiple sequential measurements are recorded with a systematic deviation from the original database data, this is an indication of movement of an object rather than a signaling anomaly, and the database is updated accordingly (the updated data increases in significance relative to older data). Stored data in the database can be tagged with timing information, thereby enabling dynamic patterns for certain objects to be recognized (e.g., certain objects that are present only during certain times and therefore produce correlation data that has a timing variable).

In another example, if the database lacks data for a certain parameter setting at a certain position, the device can be asked to record additional radar signals with such parameters for the already determined position, and that data is inserted into the database. When new radar signals are received that deviate significantly from recorded data so that no match can be concluded with high probability, the device can perform an updated radar recording with a different parameter setting, and correlate that newly acquired sense data against the related database (if such a database exists for additional parameter settings).

In still another example, the database content can initially (to some extent) be populated with estimated radar response data based on modeled reflections from a detailed map of the environment. For a limited set of positions, this data can be validated with an Enhanced Device having additional sensors to assist in determining position. This initial synthetically generated data can then be iteratively replaced or improved based on the above described approach.

In an alternative embodiment, devices having an IMU, accelerometer, or similar sensor, are able to estimate their trajectory and distance. Sense data collected from these devices is then used to further update the database of radar signals at estimated positions if there are no such prior data as long as the confidence in the trajectory and distance estimates is high enough (e.g., above a certain threshold). Furthermore, in those cases where there are prior radar signals, the system can use the method as described above to determine the most likely position, and in case of ambiguity it can also compare with the estimated trajectory and, based on that comparison, identify certain radar data that deviate between the radar measurement and the database and degrade their significance (a potential indication that the environment has changed, e.g., objects have moved). One key advantage of the technology described herein is that not all devices need to be equipped with such additional sensors, and if only a few have them, these can help improve the database for all devices.

It is noted that embodiments consistent with the invention utilize a database of radar signal templates corresponding to different WR-Frames. The database may be used for off-device position estimation in a separate node or entity, such as an edge cloud server. The node may create and maintain the database. It may then receive radar observation data from the device (e.g., in 1-bit and high-resolution representations as discussed above). The node then performs position estimation based on correlating the radar data and may return a position estimate to the device.

The database may also be used for on-device position estimation. A separate node or entity, such as an edge cloud server, may create and maintain the database and provide it to the device. The device in such embodiments uses its radar observation data (e.g., initially in 1-bit and then in high-resolution representations as discussed above), to perform position estimation based on correlating the radar data to the database information.

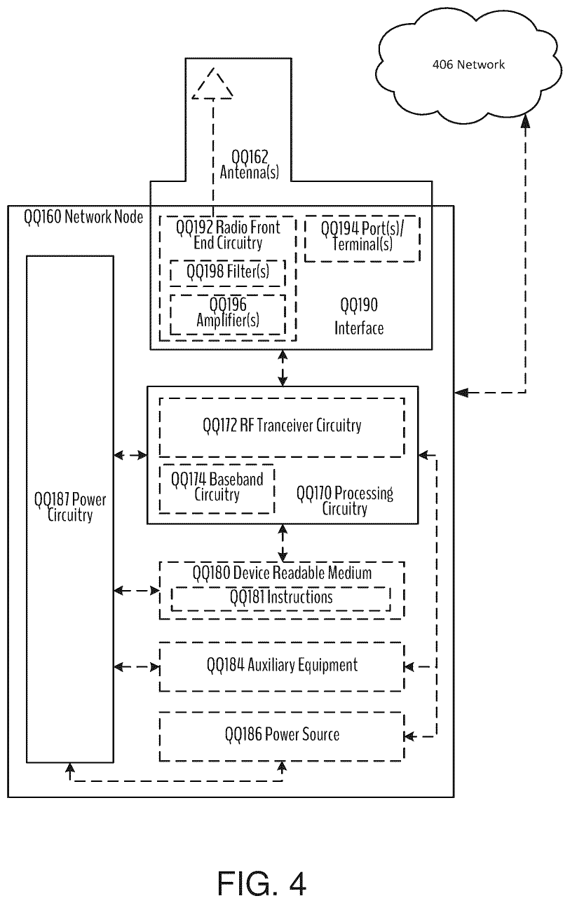

To further illustrate aspects of some but not necessarily all embodiments consistent with the invention, FIG. 4 shows details of a network node QQ160 according to one or more embodiments. In FIG. 4, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network 406 of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a radio network controller (RNC) component, or a base transceiver station (BTS) component and a base station controller (BSC) component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions QQ181 stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or wireless devices via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 4 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

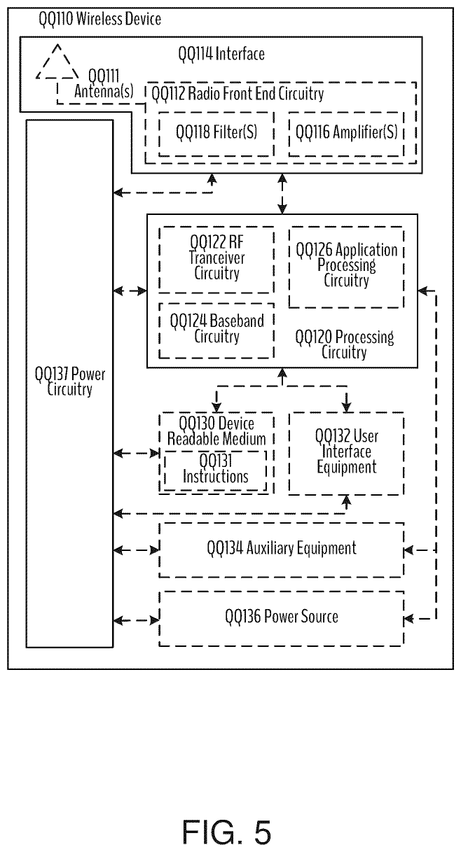

To further illustrate aspects of some but not necessarily all embodiments consistent with the invention, FIG. 5 shows details of a wireless device QQ110 according to one or more embodiments. As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine-type communication (MTC) device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

FIG. 5 shows details of a wireless device QQ110 according to one or more embodiments. As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions QQ131 stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a System On a Chip (SOC). In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions QQ131 stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes (e.g., radar functionality as described herein), interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

Embodiments consistent with the invention provide a number of advantages over conventional technology. For example, and without limitation:
Embodiments consistent with the invention provide a simplified first correlation with single bit representation, to discard most candidate positions. This leads to faster and energy efficient processing.
The second correlation can compare just those parts of signals that actually contain echoes and not those portions that were previously found (in the first correlation) to lack reflections. Also in some but not necessarily all embodiments, even among those signals that do contain echoes, only those signals that would add value in the positioning determination are processed, rather than all of them. Each of these aspects saves on required storage and computations.
Embodiments consistent with the invention compare both relative levels and shapes of echoes, with well-defined error measures.
Embodiments consistent with the invention make it possible to control the radar signal round trip time to be included in the comparison (i.e., how distant echoes should be included in the comparison).
Embodiments consistent with the invention make it possible to have distance dependent echo matching requirements, to give closer echoes higher weighting in the calculated fine position.
Embodiments consistent with the invention make it possible to create multiple data sets capturing objects at different distance ranges (e.g., multiple “annuli”).
Embodiments consistent with the invention make it possible to make exceptions for a number of un-matched echoes to account for changes in the scene.

The invention has been described with reference to particular embodiments. However, it will be readily apparent to those skilled in the art that it is possible to embody the invention in specific forms other than those of the embodiment described above.

For example, throughout this document terms such as “single bit”, “1-bit”, and other comparable terms are used and illustrated by exemplary embodiments involving only one binary digit to represent a radar reflection signal magnitude. However, usage of such terms is not intended to restrict the invention to only embodiments involving one binary digit. To the contrary, terms such as “single bit”, “1-bit”, and the like are to be construed to cover any representation of a value having only two states, regardless of how many binary digits are used to encode those states, and regardless of how any such binary digits are encoded.

Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of determining a position of a mobile communication device, comprising:
obtaining a first set of candidate signal templates, wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy;
obtaining a first radar echo signal;
producing a first test signal (NE′, E′, SW′) by encoding magnitude values of the first radar echo signal in accordance with the first magnitude encoding strategy;
correlating the first test signal with each candidate signal template in the first set of candidate signal templates to obtain a first set of respective correlation results;
producing a second set of candidate positions by using the first correlation results as a basis for selecting fewer than all of the candidate positions from the first set of candidate positions; and
obtaining a second set of candidate signal templates, wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy.

2. The method of claim 1, wherein:
the first magnitude encoding strategy comprises representing each signal magnitude by a magnitude value selected from only two possible values; and
the second magnitude encoding strategy comprises representing each signal magnitude by a magnitude value selected from more than two possible values.

3. The method of claim 1, comprising:
obtaining a second test signal by encoding magnitude values of the first radar echo signal in accordance with the second magnitude encoding strategy; and
determining the position of the mobile communication device by correlating the second test signal with each candidate signal template in the second set of candidate signal templates.

4. The method of claim 1, comprising:
obtaining a second test signal by obtaining a second radar echo signal and encoding magnitude values of the second radar echo signal in accordance with the second magnitude encoding strategy; and
determining the position of the mobile communication device by correlating the second test signal with each candidate signal template in the second set of candidate signal templates.

5. The method of claim 1, wherein each of the candidate position templates in the first set of candidate signal templates and each of the candidate position templates in the second set of candidate signal templates is further associated with a direction of radar signal transmission.

6. The method of claim 1, wherein each of the candidate position templates in the first set of candidate signal templates and each of the candidate position templates in the second set of candidate signal templates comprises information indicating a measure of radar echo signal energy and a time delay corresponding to the radar echo signal energy.

7. The method of claim 6, wherein correlating the first test signal with each candidate signal template in the first set of candidate signal templates to obtain a first set of respective correlation results comprises:
using the information indicating the time delay corresponding to the radar echo signal energy as a basis for applying different weights to different correlation results of the first set of correlation results.

8. The method of claim 1, comprising:
selecting, as the position of the mobile communication device, one of the candidate positions that correspond to the candidate signal templates of the second set of candidate signal templates, wherein the selecting is based on correlation results obtained by correlating the second test signal with each candidate signal template in the second set of candidate signal templates.

9. The method of claim 1, comprising:
obtaining an initial estimate of the position of the mobile communication device, wherein the initial estimate of the position of the mobile communication device is derived from one or more of:
signaling from a global satellite positioning system; and
Observed Time Difference Of Arrival, OTDOA, technology;
Round Trip Time, RTT, technology;
Angle of Arrival, AoA, technology;
Angle of Departure, AoD, technology; and
UpLink Time of Arrival, UL ToA, technology; and
selecting the first set of candidate signal templates from a plurality of different sets of candidate position templates, wherein the selecting is based on the initial estimate of the position of the mobile communication device.

10. The method of claim 1, wherein:
obtaining the first radar echo signal comprises the mobile communication device transmitting a radar signal and receiving the first radar echo signal; and
correlating the first test signal with each candidate signal template in the first set of candidate signal templates to obtain the first set of respective correlation results is performed by the mobile communication system node that serves the mobile communication device.

11. The method of claim 1, wherein correlating the first test signal with each candidate signal template in the first set of candidate signal templates to obtain the first set of respective correlation results is performed by the mobile communication device.

12. A non-transitory computer readable storage medium comprising a computer program comprising instructions that, when executed by at least one processor, causes the at least one processor to carry out a method of determining a position of a mobile communication device, wherein the method comprises:
obtaining a first set of candidate signal templates, wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy;
obtaining a first radar echo signal;
producing a first test signal by encoding magnitude values of the first radar echo signal in accordance with the first magnitude encoding strategy;
correlating the first test signal with each candidate signal template in the first set of candidate signal templates to obtain a first set of respective correlation results;
producing a second set of candidate positions by using the first correlation results as a basis for selecting fewer than all of the candidate positions from the first set of candidate positions; and
obtaining a second set of candidate signal templates, wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy.

13. (canceled)

14. An apparatus for determining a position of a mobile communication device, the apparatus comprising:
circuitry configured to obtain a first set of candidate signal templates, wherein each candidate signal template in the first set of candidate signal templates corresponds to a respective candidate position of a first set of candidate positions, and wherein magnitude values in each candidate signal template in the first set of candidate signal templates are encoded in accordance with a first magnitude encoding strategy;
circuitry configured to obtain a first radar echo signal;
circuitry configured to produce a first test signal by encoding magnitude values of the first radar echo signal in accordance with the first magnitude encoding strategy;
circuitry configured to correlate the first test signal with each candidate signal template in the first set of candidate signal templates to obtain a first set of respective correlation results;
circuitry configured to produce a second set of candidate positions by using the first correlation results as a basis for selecting fewer than all of the candidate positions from the first set of candidate positions; and
circuitry configured to obtain a second set of candidate signal templates, wherein each candidate signal template in the second set of candidate signal templates corresponds to a respective one of the candidate positions in the second set of candidate positions, and wherein magnitude values in each candidate signal template in the second set of candidate signal templates are encoded in accordance with a second magnitude encoding strategy that is different from the first magnitude encoding strategy.

15. The apparatus of claim 14, wherein:
the first magnitude encoding strategy comprises representing each signal magnitude by a magnitude value selected from only two possible values; and
the second magnitude encoding strategy comprises representing each signal magnitude by a magnitude value selected from more than two possible values.

16. The apparatus of claim 14, comprising:
circuitry configured to obtain a second test signal by encoding magnitude values of the first radar echo signal in accordance with the second magnitude encoding strategy; and
circuitry configured to determine the position of the mobile communication device by correlating the second test signal with each candidate signal template in the second set of candidate signal templates.

17. The apparatus of claim 14, comprising:
circuitry configured to obtain a second test signal by obtaining a second radar echo signal and encoding magnitude values of the second radar echo signal in accordance with the second magnitude encoding strategy; and
circuitry configured to determine the position of the mobile communication device by correlating the second test signal with each candidate signal template in the second set of candidate signal templates.

18. The apparatus of claim 14, wherein each of the candidate position templates in the first set of candidate signal templates and each of the candidate position templates in the second set of candidate signal templates is further associated with a direction of radar signal transmission.

19. The apparatus of claim 14, wherein each of the candidate position templates in the first set of candidate signal templates and each of the candidate position templates in the second set of candidate signal templates comprises information indicating a measure of radar echo signal energy and a time delay corresponding to the radar echo signal energy.

20. The apparatus of claim 19, wherein the circuitry configured to correlate the first test signal with each candidate signal template in the first set of candidate signal templates to obtain a first set of respective correlation results comprises:
circuitry configured to use the information indicating the time delay corresponding to the radar echo signal energy as a basis for applying different weights to different correlation results of the first set of correlation results.

21. The apparatus of claim 14, comprising:
circuitry configured to select, as the position of the mobile communication device, one of the candidate positions that correspond to the candidate signal templates of the second set of candidate signal templates, wherein the selecting is based on correlation results obtained by correlating the second test signal with each candidate signal template in the second set of candidate signal templates.

22. The apparatus of claim 14, comprising:
circuitry configured to obtain an initial estimate of the position of the mobile communication device, wherein the initial estimate of the position of the mobile communication device is derived from one or more of:
signaling from a global satellite positioning system; and
Observed Time Difference Of Arrival, OTDOA, technology;
Round Trip Time, RTT, technology;
Angle of Arrival, AoA, technology;
Angle of Departure, AoD, technology; and
UpLink Time of Arrival, UL ToA, technology; and
circuitry configured to select the first set of candidate signal templates from a plurality of different sets of candidate position templates, wherein the selecting is based on the initial estimate of the position of the mobile communication device.

23. The apparatus of claim 14, wherein:
the circuitry configured to obtain the first radar echo signal comprises mobile communication device circuitry configured to transmit a radar signal and circuitry configured to receive the first radar echo signal; and
the circuitry configured to correlate the first test signal with each candidate signal template in the first set of candidate signal templates to obtain the first set of respective correlation results is associated with the mobile communication system node that serves the mobile communication device.

24. The apparatus of claim 14, wherein the circuitry configured to correlate the first test signal with each candidate signal template in the first set of candidate signal templates to obtain the first set of respective correlation results is associated with the mobile communication device.
